(19) United States
(12) Patent Application Publication
(10) Pub. No.: US 2005/0246758 A1
(43) Pub. Date: Nov. 3, 2005

(54) Authoring system and method for supplying tagged media content to portable devices receiving from plural disparate sources

(75) Inventors: Rajesh Bhagwandas Khandelwal, Bridgewater, NJ (US); Chieh-Chung Chang, Monmouth Junction, NJ (US); Yue Ma, West Windsor, NJ (US); Alan Kaplan, Princeton, NJ (US); David Alan Braun, Denville, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD., Kadoma-shi, Osaka (JP)

(21) Appl. No.: 10/509,962

(22) PCT Filed: Mar. 31, 2003
(86) PCT No.: PCT/US03/09877

§ 371 Date: Jun. 2, 2005

Related U.S. Application Data
(60) Provisional application No. 60/370,498, filed on Apr. 5, 2002.

(51) Int. Cl. H04N 7/173; H04N 5/38; H04N 7/16

(52) U.S. Cl. 725/138; 725/116; 725/117; 725/135; 348/723

(57) ABSTRACT

A system and method for supplying media content from disparate sources includes tagging media content with an identifier tag useful in synchronization with additional media content, and useful in delivery of the media content. In other aspects, the media content is transmitted to a distribution mechanism adapted to distribute the media content to media delivery devices. In yet another aspect, the media delivery device is adapted to obtain additional media content from a disparate source, adapted to synchronize the media content with the additional media content according to the identifier tag, and adapted to deliver the media content to a consumer according to the identifier tag.

### FIELD OF THE INVENTION

The present invention relates generally to interactive television and multimedia systems. More particularly, the invention relates to an authoring system and method for supplying tagged content that will allow a handheld device in communication with a broadcast source and other information sources to synchronize the information received.

Interactive television holds much promise as the information delivery system of the future. It also presents a number of problems that remain to be solved. There are various methods for deploying a multimedia experience. One method focuses on using a broadcast medium, such as the broadcast television medium, as the basic information channel, to which interactive capabilities will be added. Another method advocates the use of packet-based (e.g., Internet) media delivery channels that would support both streaming video and user interactive features. Yet another method utilizes external memory sources such as compact disk (CD), secure digital (SD), etc. through suitable distribution channels.

We believe that these interactive multimedia delivery approaches can be enhanced through integration with a variety of handheld portable devices that are capable of receiving information from a plurality of disparate information sources. By way of example, audio/video remote control devices may be enhanced to include the capability of wireless communication with broadcast delivery sources, packet delivery sources, and memory-based sources. So equipped, the handheld remote could serve as a very useful component of an interactive television for interactive multimedia system. The remote control would be capable of receiving information from the broadcast source, including electronic program guide (EPG) information and other digital content. The remote control would also be capable of receiving digital information from other information sources such as the internet, by wirelessly communicating with a suitable portal device such as a gateway. The remote control is also capable of accessing digital information from other memory based storage sources such as CD, SD, etc. The information received from these disparate information sources would then be integrated or synchronized within the remote control device to support a variety of different interactive features.

Because the remote control device is typically used within the television or multimedia viewing environment, it serves as an excellent handheld device for providing enhanced interactive experiences. The remote control device is not the only portable device with which the invention may be used, however. As will be appreciated from the following specification, the principles of the invention can be used with a variety of different portable devices. In this regard, there are currently numerous portable devices in popular use. These include personal digital assistants (PDAs), cellular telephones, audio/video remote controls, portable radios, televisions and video players, and the like. As these devices become more powerful, many expect the functions of these devices will merge. This merger will transform the portable device into a powerful platform for delivery of commercial services to consumers.

A promising application for portable devices is to integrate media content received from disparate sources, such as from broadcast media and from the internet. One problem that system designers currently face in this regard is how to implement the backchannel (the channel by which the consumer communicates back to the content provider). Providing a backchannel is comparatively easy on the internet, but it is more difficult to do so with broadcast sources, because broadcast is characteristically one-way communication, hence alternative communication methods must be deployed.

### SUMMARY OF THE INVENTION

The present invention address the foregoing problems by providing an authoring system and method that allows content suppliers to tag data that will later be delivered through different disparate sources. By supplying tags during the authorship phase, the tagged data can be automatically integrated later within the user's portable device—even if that portable device is not able to establish a backchannel connection.

The invention includes a high level data flow system and method whereby the mobile device receives information from plural disparate sources, including at least one broadcast source. An authoring system tags the information being sent to the mobile device and the mobile device includes synchronization systems that use the tags to integrate the disparate information for use in a handheld device. While it is possible to include a backchannel in the handheld device, a backchannel is not required as the authoring system pre-tags information to allow the mobile device to integrate it. In one embodiment the broadcast source comprises an analog video source, such as a conventional NTSC, PAL, or SECAM broadcast source. In another embodiment the broadcast source comprises a digital video source such as an MPEG broadcast source. And yet another embodiment the broadcast source comprises a streaming media source delivered using a packet-based delivery system over a network such as the internet.

As will become more apparent from the following detailed description, the invention makes possible an information delivery architecture that will work regardless of whether a backchannel is ordinarily provided. The invention allows broadcast system operators and media developers to integrate content that can then be delivered over multiple, diverse sources. Thus broadcast media and internet information can be integrated and used by the end user operating one of a variety of different portable devices. The invention thus enhances not only the broadcast system platform but also the portable device platforms (e.g., cellular telephones, audio/video remote controls, personal digital assistants and other smart consumer appliances).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an exemplary multimedia system illustrating the use of the authoring system in an exemplary application;

FIG. 2 is a detailed block diagram illustrating one presently preferred system architecture for delivery of tagged content to a portable device such as a PDA, and showing the data flow whereby the authoring system provides tagged content;

FIG. 3 is a data flow diagram illustrating how the authoring system provides tagged content and further illustrating how the portable device integrates that tagged content;

FIG. 4 is a block diagram of one a presently preferred development system utilizing the authoring system in accordance with the invention;

FIG. 5 is a data flow diagram illustrating how the authoring system embeds tags in the broadcast and web page media;

FIG. 6 is a functional block diagram of the authoring system.

### DETAILED DESCRIPTION OF THE PREFERRED EMBODIMENTS

The following description of the preferred embodiment(s) is merely exemplary in nature and is in no way intended to limit the invention, its application, or uses.

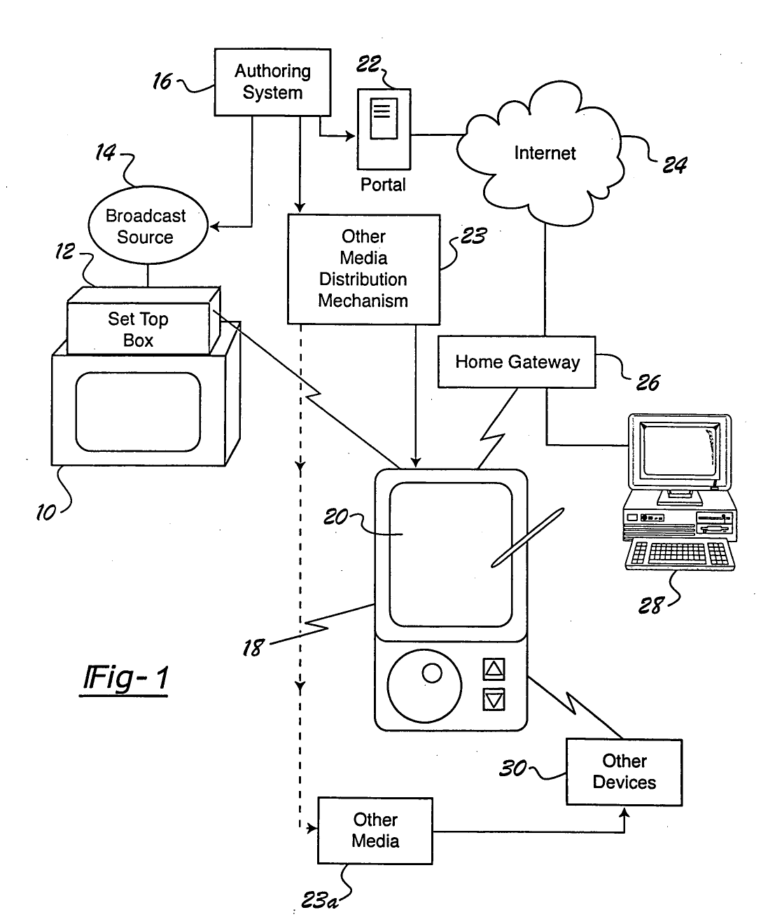

Although the invention can be deployed in a wide variety of different applications, FIG. 1 presents an exemplary application that focuses on the interactive television environment. Referring to FIG. 1, the television 10 and the associated set top box 12 receive a modulated signal from the broadcast source 14. Typically, the signal is modulated onto different channels 30 that are tuned preferably by the set top box 12. Alternatively, a digital content decoder can also be built into TV, or the portable device, or use a separate appliance box that is plugged into TV externally. As will be more fully explained below, the set top box not only selectively tunes to the channel of the user's choice, but it also decodes digital content that is placed in the broadcast screen by the content provider using the authoring system 16 of the invention. This digital content is communicated, preferably wirelessly, to the handheld device 18 (in this case a remote control device with PDA-like viewing and data entry screen 20).

The authoring system 16 also delivers digital content to a suitable server 22 that is coupled to an information delivery network such as the internet 24 allowing it to act as a portal through which users can access the digital content using computers and other devices. A major function of the authoring system is to send the interactive data to various sources (e.g., broadcast sources, internet, cellular, portable memory devices, and the like) from a single point of content creation. This is illustrated in FIG. 6.

Referring back to FIG. 1, the authoring system can also deliver digital content for delivery through a variety of different media delivery channels, including broadcast sources, the internet, and through alternate media delivery mechanism 23. Such mechanisms include memory-based storage systems, CD-ROMs, flash memory, SD media and the like. In the illustrated embodiment the user has a home gateway device 26 communicating via internet 24. The home gateway thus supplies internet conductivity to personal computers such as computer 28 and also to the handheld device 18, preferably via a wireless connection. Thus the handheld device 18 receives digital content from the internet 24 as well as from broadcast source 14.

In the embodiment illustrated in FIG. 1 the set top box 12 and home gateway 26 have been shown as separate units. In practice, the two may be included in a single unit that would supply both broadcast source access (e.g., cable television or satellite channels) as well as high-speed internet access (e.g., broadband access). Communication with the handheld device can be through a variety of different wireless technologies including infared technology, spread spectrum wireless technology Bluetooth technology, IEEE 802.11, and the like. This same wireless communication capability can be used to permit the handheld device to wirelessly communicate with other devices such as diagrammatically illustrated at 30. These other devices include a diverse list ranging from point-of-sale (POS) terminals to global positioning systems, to car navigation systems, VCR and DVD recorders and to other smart appliances. In this way, the handheld device might be configured to receive information from broadcast source 14, from portal 22 and then integrate that information for use in accessing or controlling some other device 30. Alternatively, the other device may be controlled by supplying it with data from some other media, such as media 23a that may be furnished by the other media distribution mechanism 23.

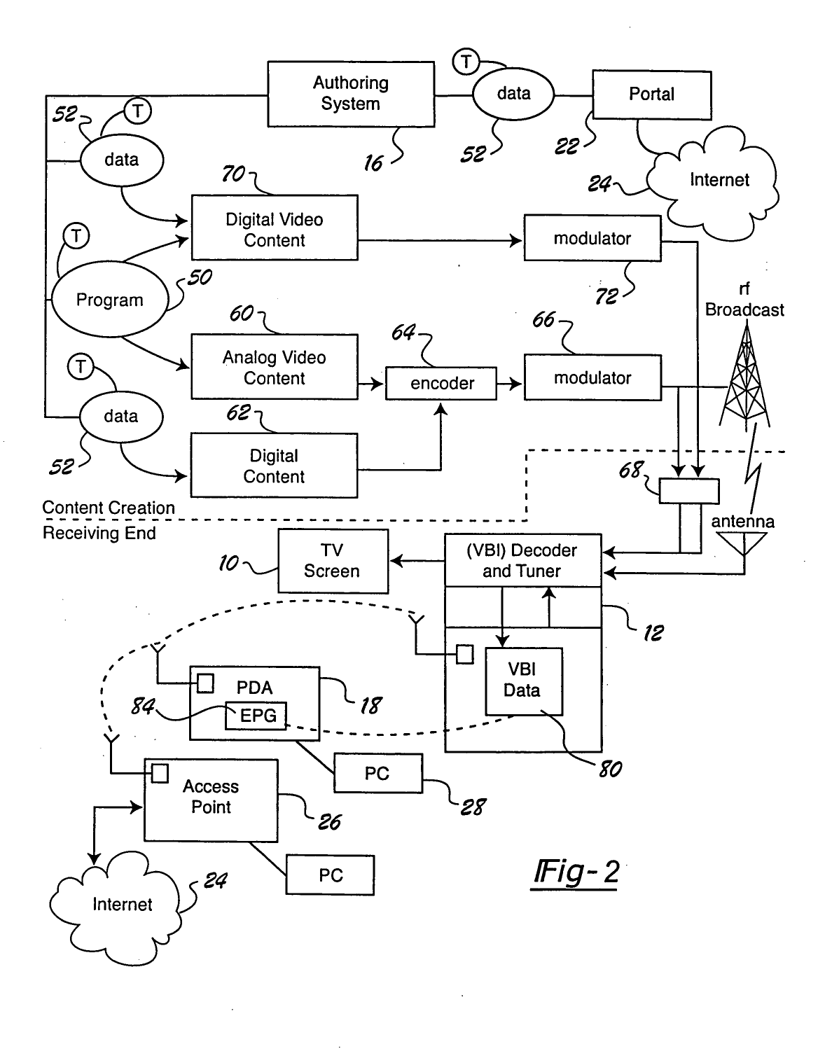

Continuing with the interactive television example introduced in FIG. 1, FIG. 2 shows in greater detail how the authoring system 16 may supply tagged content through both analog and digital video broadcast sources and through packet-delivery sources such as an internet portal source. Referring to FIG. 2, program content that will ultimately be delivered to the viewers television 10 has been illustrated diagrammatically at 50. This program content can include both entertainment content and advertising content, as desired. To provide an interactive experience, certain digital content will be associated with the program content. This digital content is diagrammatically depicted as data elements 52, shown in various locations throughout FIG. 2. In the case of an analog broadcast system, the program content 50 is supplied as analog video content 60 to which the digital content 62 (derived from data 52) is added through an encoder device 64. In this regard, the current vertical blanking interval (VBI) encoder defines protocols by which digital data are embedded in “invisible” lines in NABTS packets in an NTSC system. Once the analog and digital components have been combined in the encoder, the signal is sent to modulator 66 for placement onto the broadband delivery system such as cable system 68.

In a digital video implementation, both program content 50 and digital data content 52 may be combined directly as digital video content, as illustrated at 70. In this regard, the current MPEG-2 standard defines protocols by which both program content and data content can be combined into transport stream data packets for delivery to the customer. The digital video content is thus modulated in modulator 72 and then added to the broadband delivery source 68.

FIG. 2 has been subdivided by a dashed line into the upper half, which represents the content creation portion of the system and the lower half which represents the receiving end of the system. With reference to the receiving end portion of FIG. 2, the broadband delivery system 68 preferably couples to the set top box 12. In FIG. 2, the set top box decoder and tuner functions have been separately labeled. The tuner functionality selects one of the channels for displaying program content on the television screen 10. If any digital content has been encoded on this channel, the decoder functionality within set top box 12 extracts that digital content so that it may be supplied to the handheld device 18.

With regard to the digital data and the decoder functionality, the invention is capable of supporting a variety of different data protocols. When a digital video signal is provided, the digital content can be extracted from the data stream by using a transport stream decoder. When analog video content is provided, the digital content may be encoded within the vertical blanking interval (VBI). In FIG. 2, it is assumed that the user has tuned to channel 3 (the analog channel) thus' the digital content is encoded as VBI data. This VBI data is initially stored preferably at 80 within the memory of the set top box 12. In addition to the memory 80, the set top box includes a tuner and the necessary decoder functionality to extract the digital content (in this case illustrated as VBI content). These functions have been illustrated in FIG. 2 as functional components within set top box 12.

The set top box also preferably includes wireless communication capability to allow it to communicate with the portable device 18. Using this communication capability, the contents of memory 80 are transferred to the memory 84 within the portable device 18. The portable device 18 includes system software that is capable of parsing and using this transferred data to support a number of applications running on the handheld device, as will be more fully explained below.

While a handheld device such as device 18 represents a presently preferred embodiment, the decoder and tuner may also be configured to communicate with a personal computer and thereby supply VBI data (or other forms of encoded digital data) to the computer as well.

Once the digital data is stored within the handheld device, it may propagate by wireless communication or hard-wired communication to other devices such as other PDA devices, personal computers 28, cellular telephones, and the like.

In the illustrated embodiment, the transferred data stored at 84 may actually represent electronic program guide (EPG) information. Thus, FIG. 2 depicts the digital content at 84 as EPG information. The handheld unit 18 may be docked to a personal computer, such as computer 28 for configuration, if desired. The handheld unit 18 also communicates, preferably wirelessly, with an internet access point, such as home gateway 26, which in turn communicates with the internet 24. In this way, the handheld device 18 is able to receive information from the portal server 22 (shown in the upper half of FIG. 2). While EPG information has been illustrated at 84 it will be appreciated that the invention can receive any type of digital information from the broadcast source. EPG information is particularly useful in interactive television applications, because it can supply information about the program to which the user is tuned. This information is then integrated with other information about the program being watched that may be received via the internet through portal 22 or other external memory sources. The tags supplied by authoring system 16 provide the synchronizing capability as will be more fully explained below.

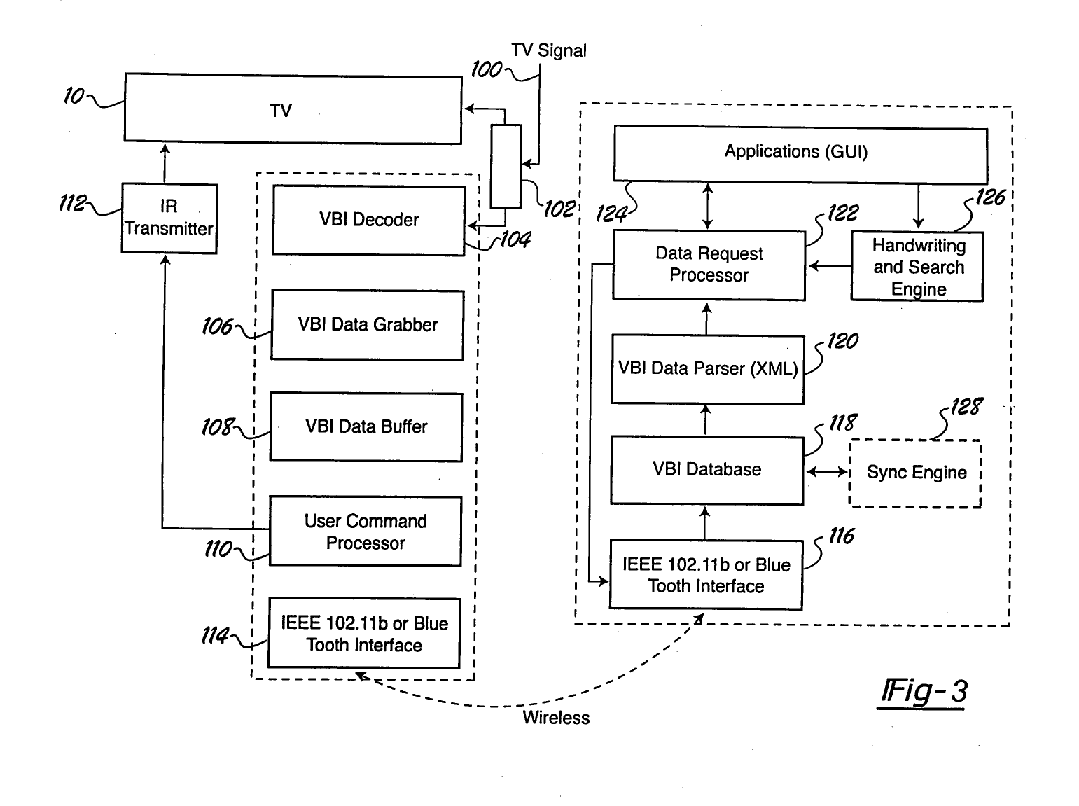

FIG. 3 shows an alternate architecture of the set top box 12 and portable device 18 in somewhat greater detail. Specifically, FIG. 3 shows how an exemplary system might be constructed to utilize VBI data. A similar architecture may be used to support other types of data (i.e., data that is not encoded for delivery within the vertical blanket interval, but rather within the main digital video transport stream).

Referring to FIG. 3, the incoming TV signal is illustrated at 100. It passes through an optional splitter 102 which feeds the signal to the television 10 and also to the decoder components of the set top box 12. Specifically, the incoming signal is supplied to the VBI decoder 104. the VBI decoder is preferably implemented as a hardware device that extracts VBI data from the incoming TV signal. The decoder can specify the TV channel and decode the VBI data transmitted in that channel. Typical VBI decoder cards available today provide on the order of 230k bits per second.

The decoder 104 supplies an output signal to the VBI data extractor 106. Because VBI data are sent only at certain time intervals on each channel, the VBI data may not be available at the instant the user requests access to it. The VBI grabber or extractor 106 is a software module that constantly grabs or extracts all available VBI data and stores it in VBI data buffer 108. The data grabber channel stamps and time stamps all VBI data so that the system will later be able to determine any necessary temporal or channel information needed to use the data.

By operating the handheld device the user may from time-to-time request VBI data from the set top box 12. The user command processor 110 within the set top box 12 responds to these requests and accesses the VBI data buffer 108 to obtain the information the user has requested. The command processor has an infared transmitter module 112 that allows it to operate as a TV remote control signal source. The processor is also coupled to a wireless interface device 114 that allows it to communicate wirelessly with the handheld device. In the presently preferred embodiment both IEEE 102.11B or Bluetooth interfaces are presently preferred.

The handheld device includes similar wireless communication capability in the form of wireless communication module 116. This module supplies data to a VBI database 118. The database is accessed by a VBI data parser 120 which in turn supplies information to the data request processor 122. The processor 122 supplies selected VBI data to any number of application programs 124 that are operating within the handheld device. If desired, handwriting analysis module 126 can be used to interpret a user's information requests and operating instructions that have been entered by a stylus. These handwriting instructions are then decoded by the module and used as instructions by the module's integrated search engine. The search engine supplies search instructions to the data request processor 122, as illustrated.

The handheld device also includes a synchronization engine 128 that preferably communicates directly with the VBI database 118. The synchronization engine performs the integration function by which VBI data and digital data downloaded from the internet are synchronized for use by the application program. The synchronization engine 128 makes use of the data tags that are applied by the authoring system 16 (FIG. 2).

The authoring system by which tags are added to the media content and to the other content such as internet web content can be implemented in a variety of different architectures. A presently preferred architecture is illustrated in FIG. 4. The authoring system 16 may be configured as an application server that integrates with a plurality of different editors, each associated with a different type of media delivery system. In the illustrated embodiment the authoring system communicates with a video media editor 140, a web development editor 142 and an other system development editor 144. This other system development editor is illustrated in FIG. 4 to demonstrate that the authoring system is capable of communicating with a wide variety of different types of media editors. The other system might be, for example, a wireless system that provides content to portable devices such as cellular telephones and suitably equipped personal digital assistants.

Each of the editors is responsible for manipulating its associated type of media content and ultimately delivering that content to a suitable media server for ultimate delivery to the viewers. In FIG. 4 the video media editor supplies its content to a media server 146 that might be net coupled to a broadcast network (e.g., television broadcast, cable TV head end or satellite system). The video media editor may have an associated database 150 containing program content being manipulated by the editor. As illustrated, the authoring system 16 may, also be coupled to one or more databases containing program content, as in database 152 and other interactive content as in database 154. The authoring system would respond to requests from the editor (e.g., video media editor 140) to integrate program content and other interactive content into the final product.

In a similar fashion the web development editor 142 supplies its output to a web portal 22. The other system development editor likewise supplies its output to a suitable portal 156. In the illustrated embodiment the portal 156 has been designated as a wireless portal as might be used to supply content to portable devices using cellular or other wireless technology.

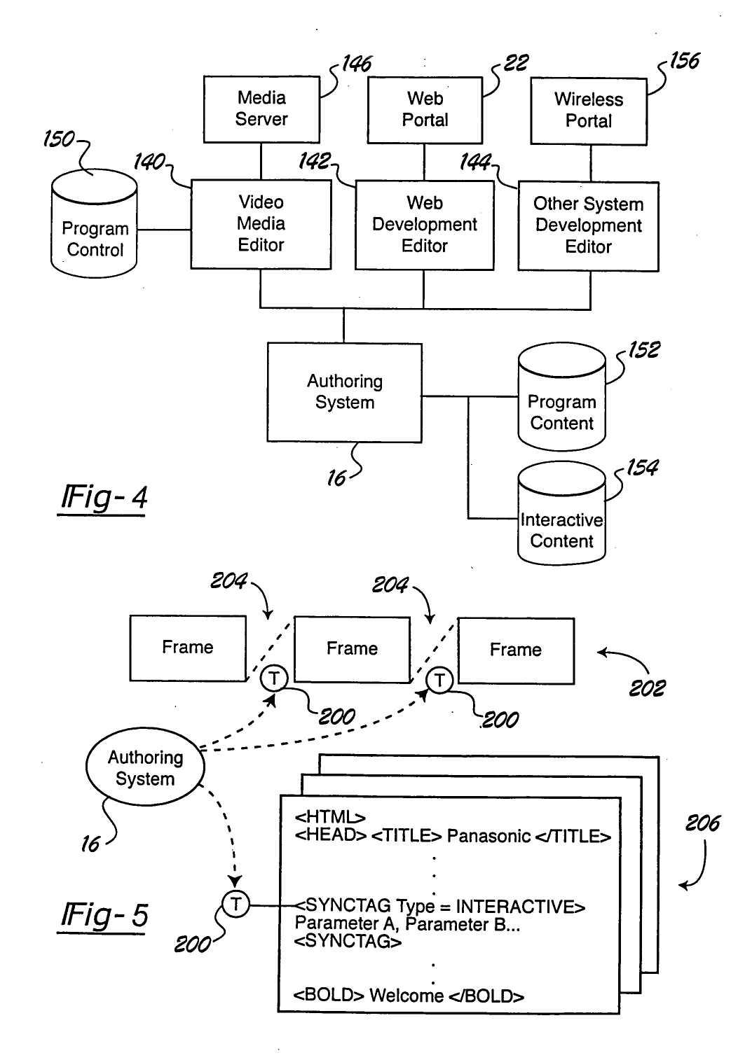

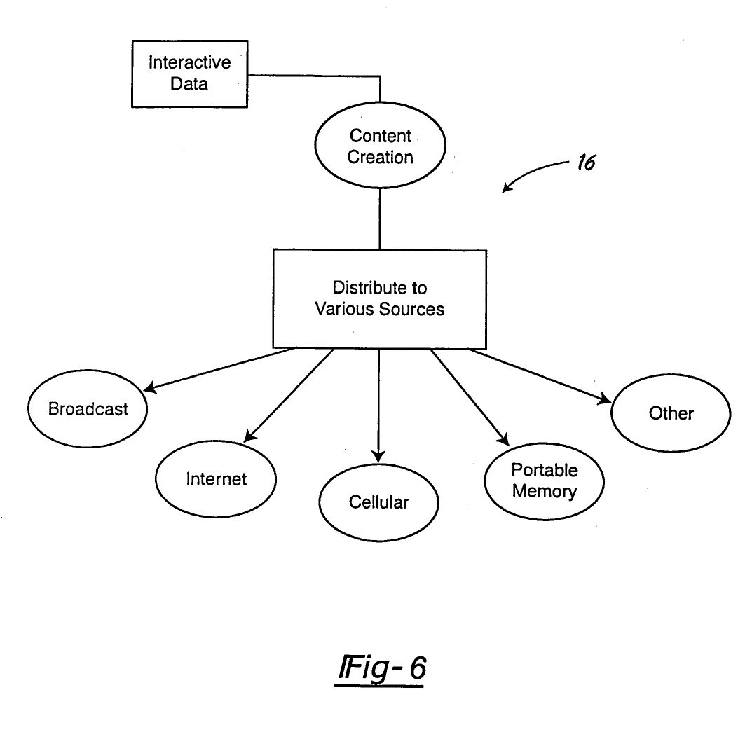

In addition to supplying program content and other interactive content to the various editors, the authoring system 16 serves the important function of generating and supplying to each of the editors a suitable tag that may be integrated into the media being edited by each of the respective editors. These tags are each designed to be compatible with the media format being developed by each editor. Although the format of the tags will depend on the nature of the media, the content of each tag is the same in this respect. The content stores synchronization information that the viewers or end users handheld devices, audio video equipment and other intelligent appliances used to synchronize the interactive components of media received from various disparate sources. The concept is illustrated in FIG. 5.

Referring to FIG. 5, the authoring system 16 delivers tags 200 to the editors for insertion into the media being edited. In the illustrated embodiment shown in FIG. 5, the media content being edited by video media editor 140 is shown at 202 as a sequence of video frames separated by a vertical blanking interval 204. As illustrated, tags 200 are inserted into the vertical blanking intervals using a format that is compatible with the video data stream. In digital broadcasting, the tags 200 are inserted into data packets that are compatible with the transport stream.

FIG. 5 also illustrates at 206 the media content being edited by the web development editor 142. As illustrated, the authoring system supplies tags 200 that are inserted into the supplemental content. Specifically, the supplemental content illustrated at 206 is in the form of a web page being developed using HTML and optionally other web development technologies. The tag 200 appears in the HTML source code as a SYNCTAG of a specified type, in this case of the “interactive” type. Embedded within the tag a plurality of parameters (Parameter A, Parameter B . . . ). These parameters represent synchronization information that are used to integrate the supplemental content with the associated video content containing corresponding tags as illustrated at 202.

In the presently preferred embodiment the tags 200 are effectively hidden within the data streams of the respective media servers. Viewers who do not own suitably equipped devices are able to view the content delivered by the respective media servers without any awareness that the media have been tagged. Viewers who are using suitably equipped devices, such as the handheld device illustrated in FIGS. 1, 2 and 3, are able to enjoy the interactive experience made possible by these embedded tags. The device parses the data stream, extracts the embedded tags and then interprets them to provide the application software running on the device with the necessary synchronization information.

The description of the invention is merely exemplary in nature and, thus, variations that do not depart from the gist of the invention are intended to be within the scope of the invention. Such variations are not to be regarded as a departure from the spirit and scope of the invention.

1. A media distribution system adapted to supply media content from disparate sources, comprising:
an encoder tagging media content with an identifier tag useful in synchronization with additional media content, and useful in delivery of the media content;
an output transmitting the media content to a distribution mechanism adapted to distribute the media content to media delivery devices; and
a distribution mechanism distributing the media content to a media delivery device adapted to record a channel upon which the identifier tag arrived, adapted to obtain additional media content from a disparate source, adapted to synchronize the media content with the additional media content according to the identifier tag and the channel, and adapted to deliver the additional media content to a consumer according to the identifier tag and a remote channel control function of the media delivery device.

2. The system of claim 1, wherein said distribution mechanism is adapted to broadcast the media content to media delivery devices.

3. The system of claim 1, wherein said distribution mechanism is adapted to narrowcast the media content to a media delivery device in response to a request for the media content.

4. The system of claim 1, wherein said encoder is adapted to insert an identifier tag into a vertical blanking interval of a sequence of video frames using a format that is compatible with a video data stream.

5. The system of claim 1, wherein said wherein said encoder is adapted to insert a tag into a web page.

6. The system of claim 1, wherein the media content corresponds to a textual description.

7. The system of claim 1, wherein the media content corresponds to an image.

8. The system of claim 1, wherein the media content corresponds information in a rich text format.

9. The system of claim 1, wherein the media content corresponds to information in a binary language format.

10. The system of claim 1, wherein the media content corresponds to a link to the additional media content via a communications system.

11. The system of claim 1, wherein the media content corresponds to audio visual media content.

12. The system of claim 1, wherein said encoder is adapted to select the identifier tag based on material characteristics of the media content.

13. The system of claim 1, wherein said encoder is adapted to insert the identifier tag into a real-time distribution channel.

14. The system of claim 13, wherein said distribution mechanism is adapted to employ a real-time distribution channel to ensure delivery of the media content at a scheduled time without being affected by a distribution load.

15. The system of claim 1, wherein said encoder is adapted effectively to hide the identifier tag within a data stream to ensure that consumers not having suitably equipped media delivery devices are able to consume the media content without any awareness that the media content has been tagged, and to ensure that consumers having a suitably equipped media delivery device are able to enjoy an interactive experience facilitated by the identifier tag.

16. A method for supplying media content from disparate sources, comprising:
tagging media content with an identifier tag useful in synchronization with additional media content, and useful in delivery of the media content;
transmitting the media content to a distribution mechanism adapted to distribute the media content to media delivery devices; and
distributing the media content to a media delivery device adapted to obtain additional media content from a disparate source, adapted to synchronize the media content with the additional media content according to the identifier tag, and adapted to deliver the media content to a consumer according to the identifier tag.

17. The method of claim 16, wherein said distributing includes broadcasting the media content to media delivery devices.

18. The method of claim 16, wherein said distributing includes narrowcasting the media content to a media delivery device in response to a request for the media content.

19. The method of claim 16, wherein said tagging includes inserting an identifier tag into a vertical blanking interval of a sequence of video frames using a format that is compatible with a video data stream.

20. The method of claim 16, wherein said tagging includes inserting a tag into a web page.

21. The method of claim 16, wherein the media content corresponds to a textual description.

22. The method of claim 16, wherein the media content corresponds to an image.

23. The method of claim 16, wherein the media content corresponds information in a rich text format.

24. The method of claim 16, wherein the media content corresponds to information in a binary language format.

25. The method of claim 16, wherein the media content corresponds to a link to the additional media content via a communications system.

26. The method of claim 16, wherein the media content corresponds to audio visual media content.

27. The method of claim 16, comprising selecting the identifier tag based on material characteristics of the media content.

28. The method of claim 16, wherein said tagging includes inserting the identifier tag into a real-time distribution channel.

29. The method of claim 16, wherein said transmitting and distributing include employing a real-time distribution channel to ensure delivery of the media content at a scheduled time without being affected by a distribution load.

30. The method of claim 16, wherein said tagging includes effectively hiding the identifier tag within a data stream to ensure that consumers not having suitably equipped media delivery devices are able to consume the media content without any awareness that the media content has been tagged, and to ensure that consumers having a suitably equipped media delivery device are able to enjoy an interactive experience facilitated by the identifier tag.

31. A method of disseminating information for use in a portable device, comprising:
generating first content adapted for dissemination from a broadcast source;
generating second content adapted for dissemination from an information source;
using an authoring system to apply tags to said first and second content, the tags being configured to define an integrating relationship between the first content and the second content;
providing said first content to a broadcast source adapted to broadcast to a portable device;
providing said second content to an information source adapted to supply information upon demand to said portable device; and
providing the portable device, wherein the portable device has ability to synchronize and deliver said first content and said second content based on a channel upon which said first content was broadcast to the portable device, and based on a channel remote control function of the portable device.
